(19) United States
(12) Patent Application Publication
(10) Pub. No.: US 2021/0387681 A1
(43) Pub. Date: Dec. 16, 2021

(54) Pickup truck cargo box wall extender and bed

(71) Applicant: Wanda Perez, Bayamon, PR (US)

(72) Inventor: Antonio Vazquez Solano, Bayamon, PR (US)

(21) Appl. No.: 17/342,385

(22) Filed: Jun. 8, 2021

Related U.S. Application Data
(60) Provisional application No. 63/037,436, filed on Jun. 10, 2020.

(51) Int. Cl. B62D 33/027

(52) U.S. Cl. CPC B62D 33/0276

(57) ABSTRACT

A pickup truck cargo box extension assembly includes a first and second side walls which pivots to the inside of the cargo box, two four-bar mechanism in the front, one at each side in front and another pivoting wall on the back of the cargo box. There are two actuators in the back outside of the cargo box connected to the side walls to provide for linear translation of the first and second walls between an extend height upward position and a retracted position.

### BACKGROUND OF THE INVENTION

The goal of the device is to create a cargo box extender for a pickup truck that allows, when in an upward position, to increase the cargo box's overall height, permitting to carry up to 500 lb. over the cabin roof from front to back of the cargo box. When the side walls of the cargo box are in a lowered position, closed, it works as a bed, protecting the interior of cargo box including all the articles located inside and enhancing the aesthetics of the pickup truck.

### BRIEF SUMMARY OF THE INVENTION

The device is an easy-to-install pickup cargo box extender comprising an installation kit that includes all the materials, all the bars, mechanisms, and walls. The invention works by providing a pickup cargo box extender when it is in an upward position, allowing to lift long materials over its base but also, when closed, serve as a bed, protecting what is inside the cargo box and enhancing the pickup aesthetics with its sleek and unique design.

### BRIEF DESCRIPTION OF THE DRAWINGS

FIG. 1 shows a side-view of the front pillars of the cargo box.

FIG. 2 shows the cargo box in a closed position.

FIG. 3 shows the back pillars of the cargo box with panels in the closed position.

FIG. 4 shows the back pillars of the cargo box with panels in the open position.

FIG. 5 shows a perspective view of the cargo box with panels in the open position.

FIG. 6 shows a side-view of the cargo box with panels in the closed position.

FIG. 7 shows a side-view of the cargo box with panels in the open position.

FIG. 8 is an expanded view of the front pillars of the cargo box.

### DETAILED DESCRIPTION OF THE INVENTION

Once the pickup cargo box extender is installed the front pillars 10 and the back pillars 11 along with the back actuators 12a, 12b makes the necessary displacement of the four-bar mechanism on the front of the cargo box CB actioned with the brushless electric motor 14a via the sprocket-chain system 15 (comprising a sprocket gear SG and corresponding chain CH) and the single bar mechanism on the back actioned also with brushless electric motor 14b, allowing the back wall BW to be extended, the panels P1, P2 are extended with the two actuators 12 that are installed on the back of the cargo box CB. When both actuators 12 are actioned, they permit the panels P1, P2 to go upwards permitting all the cargo box CB to be extended and allowing to lift a max of 500 lb. from the top of the cabin roof until the back end of the pickup truck. When the complete system is in a closed position it serves as a cargo box bed that provides protection to the articles that are inside the cargo box. When closed, it is an aesthetic enhancer to the entire pickup. The cargo box extender also includes a control panel and corresponding circuitry for controlling the opening and closing of the panels P1, P2.

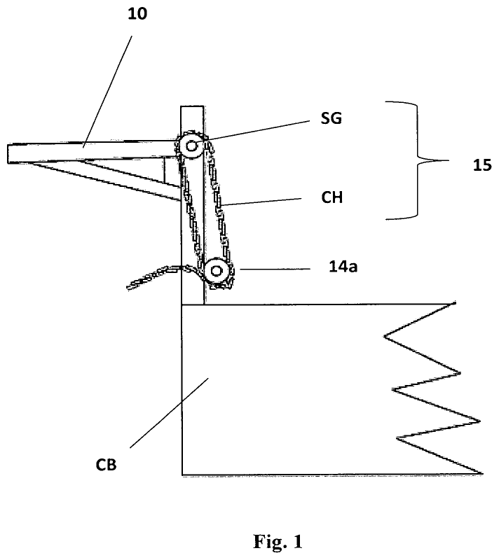

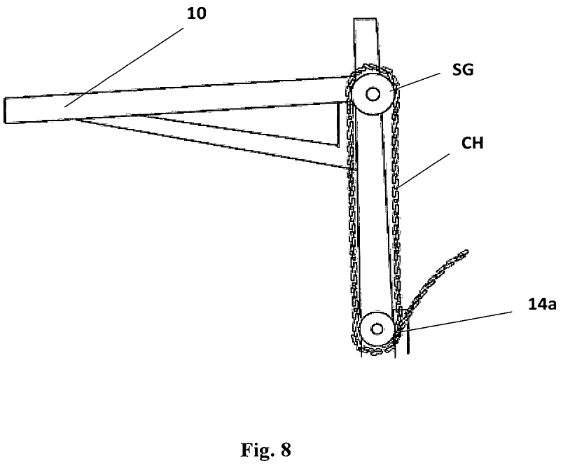

FIGS. 1 and 8, show the four-bar mechanism 13 used in both ends at the front of the cargo box CB comprising an electric motor 14a and a sprocket-chain system 15 to change from the lowered position to the raised position.

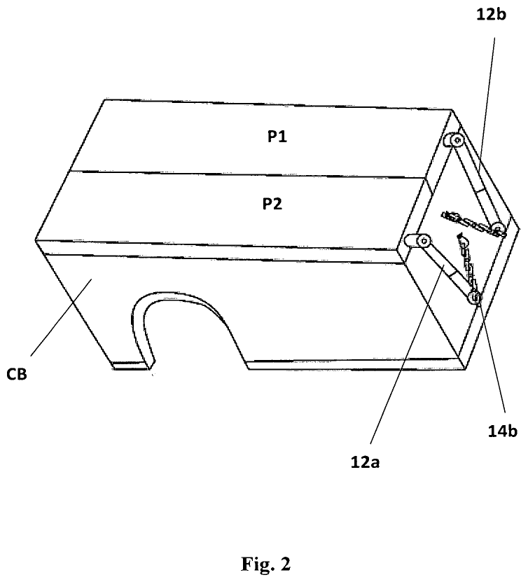

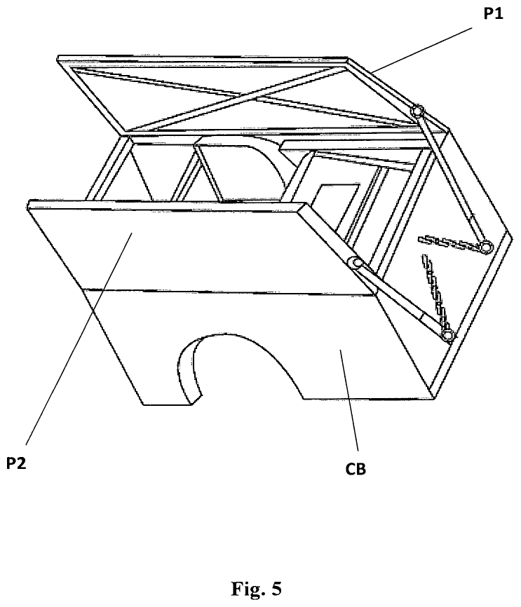

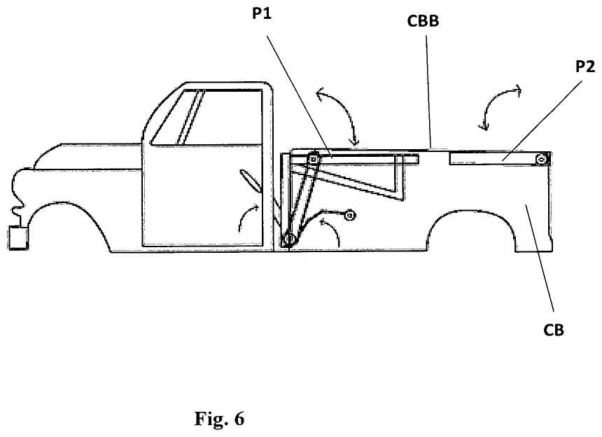

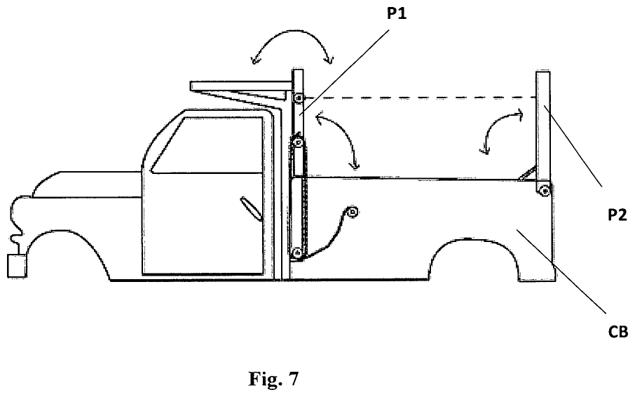

FIGS. 2-5 show the two panels P1, P2 in a closed position. When the panels P1, P2 are closed, the cargo box CB is converted into a cargo box bed CBB, that protects whatever is placed inside the cargo box. Conversely, when the panels P1, P2 are in a raised position, they act as a vertical extension of the cargo. As such, the panels are a cargo box wall extender. The panels P1, P2 can be manufactured from plastic or any durable material resistant to the elements. In this embodiment the panels are connected or hinged to the side walls of the cargo box CB. However, as shown in FIGS. 6 and 7, the panels may also be connected or hinged to the front and back walls of the cargo box CB.

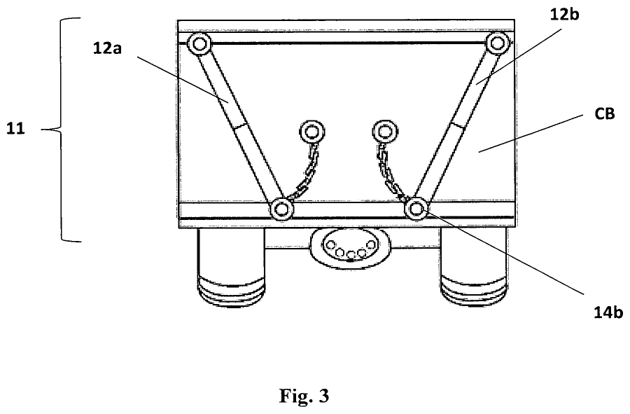

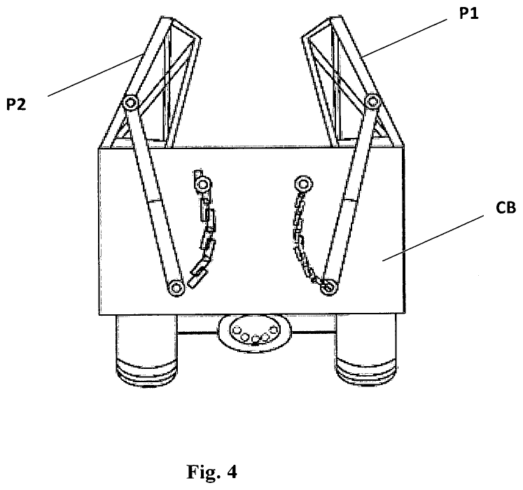

FIG. 3-4 shows the actuators 12a, 12b that are part of the back pillars 11 and whose purpose is to exert the linear displacement to get the panels P1, P2 plastic panels from their lowered position to their raised position.

Moreover, FIG. 8 shows the four-bar mechanisms on the front of the cargo box CB and the single bar mechanism on the back. All four mechanisms presented are moved by brushless electric motors. The motors 14a, 14b allow the mechanisms to change from their lowered position to their raised and fully extends positions.

1. A pickup cargo extender bed assembly, comprising:
a pickup cargo bed including first and second side walls, wherein the first and second side walls include;
two hard plastic panels each measuring half-length and half-width of the pickup cargo box, divided on the very center from front to back, creating one entire bed when closed together and creating two lateral walls extenders when open in upward position, one to the left and one to the right, wherein each one creates a top side when extended;
wherein each panel is attached to the pickup cargo in two points each where connects pivoting mechanism to the pickup cargo original side walls; and
first and second actuators, located in the back of the pickup cargo box wherein the first and second side walls are mounted in vertical tracks that provide for linear translation of the first and second rails between an extended upward position and a retracted downward position.

2. The pickup cargo box bed assembly of claim 1, wherein the side walls are connected to an actuator in order to move the side walls between the extended and retracted positions.

3. A pickup cargo box extender bed assembly, comprising:
two four-bar mechanism in the front, one at each side in the front corners of the cargo box; wherein each one creates a top side when extended;
a first four-bar mechanism equipped with a sprocket-chain system and a brushless electric motor to provide linear displacement and change the position of the four-bar mechanism to create a top side; and
a second four-bar mechanism equipped with a sprocket-chain system and a brushless electric motor first four-bar mechanism equipped with a sprocket-chain and an electric motor to provide linear displacement and change the position of the four-bar mechanism to create a top side; and
both front four-bar mechanisms being operated acting together creates a top side serving as a base over the pickup cabin roof while still being the front pillars of the box extender;

4. The pickup cargo box bed assembly of claim 3, wherein the first and second four-bar mechanisms are attached to the cargo box floor and they remain attached into that position regardless to their actual state and extend horizontally above the cabin roof when the position be extended.

5. The pickup cargo box bed assembly of claim 3, wherein both front pillars are connected to a brushless electric motor that allows the four-bar mechanisms to extend and retract them through the sprocket-chain systems.

6. A pickup cargo box extender bed assembly, comprising:
two single bars attached to the pickup cargo box through a pivoting mechanism, one at each side in the back corners of the cargo box; wherein each one creates a top side when extended;
both back single bar mechanisms being operated acting together creates a top side serving as a base on the back while still being the back pillars of the box extender;
the two single bars are interconnected by a horizontal bar which is welded to both single bars.

7. The pickup cargo box bed assembly of claim 6, wherein each bar is connected to an electric motor to allow pivoting movement from zero-degree position to a 90-degree position, from lowered to raised position.
